(19) United States
(12) Patent Application Publication
(10) Pub. No.: US 2015/0370548 A1
(43) Pub. Date: Dec. 24, 2015

(54) Automated Mobile Application Publishing

(71) Applicant: Google Inc., Mountain View, CA (US)

(72) Inventors: John Ayres, London (GB); Elizabeth Ireland Powers, London (GB); Nicolas Fortescue, Oxford (GB); Andrea Ambu, London (GB)

(21) Appl. No.: 14/311,370

(22) Filed: Jun. 23, 2014

(51) Int. Cl. G06F 9/445

(52) U.S. Cl. CPC G06F 8/60; G06F 8/65

(57) ABSTRACT

Systems, device and techniques are disclosed for publishing multiple versions of an application to an application market, via an application programming interface. The application programming interface may be configured to allow automated uploads of multiple version of an application without requiring individual uploads of each version. A developer associated party may provide the multiple versions of the application via the application programming interface. The multiple versions of the applications may be provided via the application programming interface and not an application market interface. The multiple versions may be published in an application to different set of users.

### BACKGROUND

The number of applications developed by mobile developers is increasing. At the same time mobile application stores are requiring more catalogue information about an uploaded application such as, for example, screenshots at multiple sizes and resolutions, localized graphics, store listing details in multiple languages, and the like. Additionally, mobile application stores may also require specific binaries for specific user device configurations. For example, a mobile application store may require a first version of an application for a user device with a 1 GHz processor and a second version of the application with a 2.5 GHz processor. These features require careful configuration, and such configurations can become large and complex. This may result in overly cumbersome uploads of multiple versions of a single application to an application store.

### BRIEF SUMMARY

According to implementations of the disclosed subject matter, an application programming interface may be provided to a developer associated party. The application programming interface may be configured to allow automated uploads of multiple version of an application without requiring individual uploads of each version. A first version and a second version of the application may be received from the developer associated party, via the application programming interface. The first version of the application may be published in a first language, in an application market, to a first set of users. The second version of the application may be published in a second language, to a second set of users. The application programming interface may be configured to receive the first version of the application and the second version of the application based on a single activation. The single activation may be a button press, a code input, an upload command, or the like.

According to implementations of the disclosed subject matter, an application programming interface may be provided to a developer associated party. A means to configure the application programming interface to allow automated uploads of multiple versions of an application without requiring individual uploads of each version may be provided. A means to receive a first version and a second version of the application, from the developer associated party, via the application programming interface may be provided. The first version of the application may be published in a first language, in an application market, to a first set of users. The second version of the application may be published in a second language, to a second set of users. The application programming interface may be configured to receive the first version of the application and the second version of the application based on a single activation. The single activation may be a button press, a code input, an upload command, or the like.

Systems and techniques according to the present disclosure allow publishing a first version of an application in a first language and a second version of the application in a second language, via an application programming interface. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example process for publishing a first and second version of an application, according to an implementation of the disclosed subject matter.

FIG. 2 shows an example publishing of multiple versions of an application, according to an implementation of the disclosed subject matter.

FIG. 3 shows another example publishing of multiple versions of an application, according to an implementation of the disclosed subject matter.

FIG. 4 shows a computer according to an implementation of the disclosed subject matter.

FIG. 5 shows a network configuration according to an implementation of the disclosed subject matter.

### DETAILED DESCRIPTION

Techniques disclosed herein enable publishing multiple versions of an application to an application market, via an application programming interface. The application programming interface may be configured to allow automated uploads of multiple version of an application (e.g., an English version, a Spanish version, a mobile device specific version, etc.), without requiring individual uploads of each version. A developer associated party (e.g., a developer, a translator, a third party uploading service, etc.) may provide the multiple versions of the application via the application programming interface. A developer may use developer software to interact with the application programming interface. Notably, the multiple versions of the applications may be provided via the application programming interface and not an application market interface. The multiple versions may be published in an application to different set of users. As an example of the techniques disclosed herein, a first version of an application, in English, and a second version of an application, in Spanish, may be generated by a developer. The developer may access an application programming interface to select the first and second versions of the application and submit the two versions. Subsequently, both versions may be uploaded to an application market, the first version for an English speaking locale and the second version for a Spanish speaking local. As another example, an application may be generated by a developer. The developer may access an application programming interface to select the application and submit it via an application programming interface. Subsequently, a first version of the application may be generated and published for a first subset of users. Additionally, a second version of the application may be generated and published for a second subset of users.

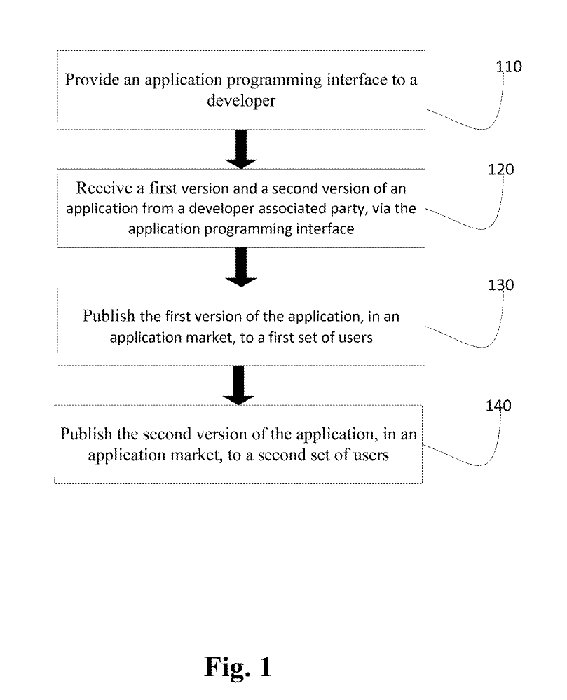

According to an implementation of the disclosed subject matter, as shown in FIG. 1 at step 110, an application programming interface maybe provided to a developer associated party. The application programming interface may enable a developer associated party to publish multiple versions of an application to an application market and may be associated with the application market such that it contains information that enables a connection with or upload to the application market. The application programming interface may specify how the developer associated party's software components should interact with each other to enable publishing multiple versions of applications to an application market. The application programming interface may contain information related to databases, computer hardware, hard disk drives, video cards, software, programs, and the like.

The application programming interface may enable a developer associated party to publish the multiple versions of an application based on a single activation. An activation may be a button press, code input, upload command, or the like. As an example of a button press, a developer associated party may select a multiple versions of an application stored on the developer's end. The developer associated party may then select a “Submit” button. Based on the selection of the submit button, the multiple versions of the application may be published, via an application programming interface. As an example of code input, a developer may execute code configured to select multiple versions of an application and to submit them via an application programming interface. The multiple versions of the application may be published to an application market based on the submission.

According to an implementation of the disclosed subject matter, as shown in FIG. 1 at step 120, multiple versions of an application may be received via the application programming interface. As disclosed herein, the multiple versions may be provided by a developer associated party such as, by the developer associated party selecting multiple stored versions of the application and submitting them via the application programming interface.

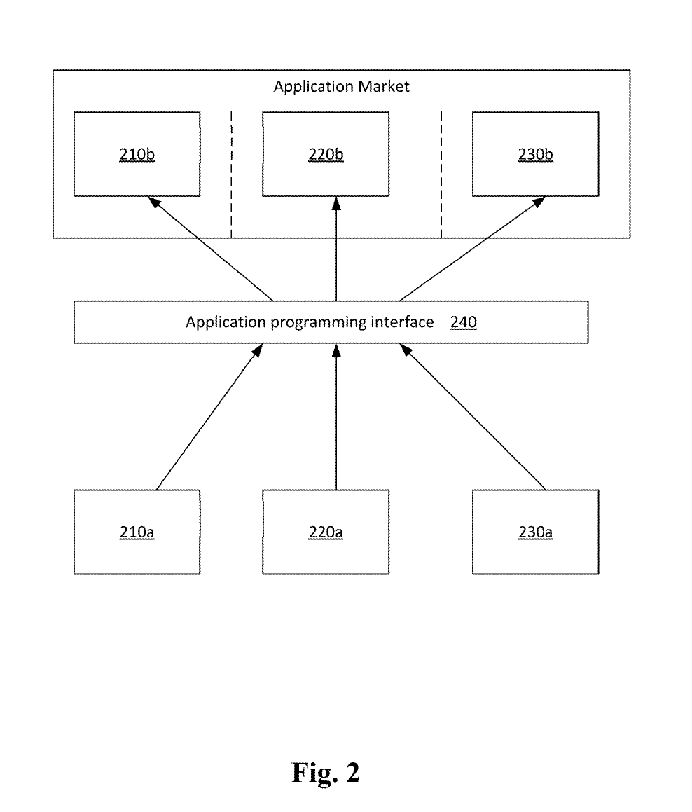

As an illustrative example, as shown in FIG. 2, multiple versions of an application 210a, 220a, and 230a may be provided to an application programming interface 240. The multiple versions 210a, 220a, and 230a may be provided by uploading a code, by a developer, the code configured to provide the application programming interface with the multiple versions of the applications such that all three versions are uploaded jointly. The application programming interface 240 may receive the multiple versions of the application and publish the three versions in an application market. The published versions of the applications 210b, 220b, and 230b may be provided to different sets of users, as disclosed herein.

Alternatively, a single version of the application may be provided, by a developer associated party, to an application programming interface. The application programming interface may be configured to generate and publish multiple versions of the application based on the provided single version.

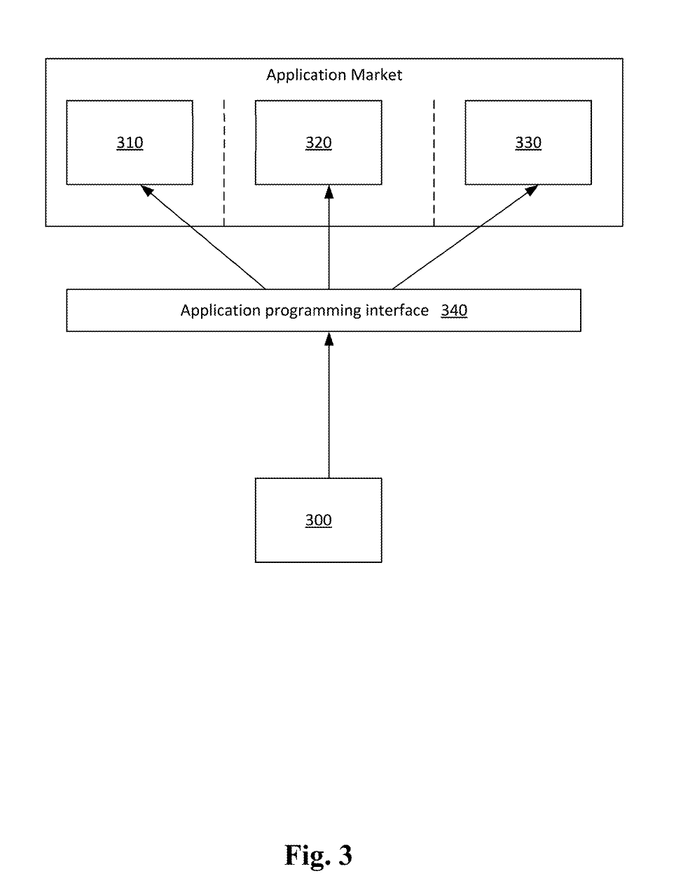

As an illustrative example, as shown in FIG. 3, a single version of an application 300 may be provided to an application programming interface 340. The single version may be provided by selecting a submit button, by a developer, the selection configured to provide the application programming interface with the single version of the application. The application programming interface 340 may receive the single version of the application and publish three versions of the application in an application market. The published versions of the applications 310, 320, and 330 may be all be distinct from each other. For example, each version of the application 310, 320, and 330 may be in a different language. The three versions of the application may be provided to different sets of users, as disclosed herein.

It will be noted that a developer associated party may be able to publish multiple versions of an application via an application programming interface, without the developer associated party individually uploading the different versions of the applications via an application market interface. The application programming interface may enable a developer to program the publishing of multiple versions of the applications without requiring the individual uploads.

One or more versions of an application provided by a developer associated party may be final versions of the application (e.g., ready to be published to an application market), or may be incomplete versions of the application to be competed via the application programming interface. As an example, a single version of an application may contain numerous variable placeholders corresponding to text in a final version of an application. As a specific example #23sdk4 may correspond to an entrance greeting. When a version of the application containing the variable #23sdk4 is provided to the application programming interface, the variable may be replaced with text corresponding to specific versions of the application. Specifically, the variable #23sdk4 may be converted to “hello” in an English version of the application and may be converted to “hola” in a Spanish version of the application. The published versions of the applications may contain the actual text (e.g., “Hello” in the English version) instead of the variable #23sdk4.

According to an implementation of the disclosed subject matter, as shown in FIG. 1 at step 130, a version from the multiple versions of an application may be published in an application market, to a set of users. A set of users may correspond to users in a specific locale, users of a certain age, users with a certain experience, users that opt in, users that opt out, user devices with one or more settings, user devises with one or more configurations, or the like. Similarly, at step 140, a different version from the multiple versions of an application maybe published to a different set of users.

A set of users may be determined based on information provided by a developer associated party, based on characteristics of a version of the application, based on the locale for which a version of the application is designated for. As an example of information provided by a developer associated party, a first version of an application may be designated as beta only. Based on the designation, this first version of the application may only be provided to users that are designated as beta users. As an example of a locale for which a version of an application is designated for, a first version of an application may be in English. Accordingly, the first version of the application may be published, via an application market, in the United States. A second version of the application may be in French. Accordingly, the second version of the application may be published, via the application market, in France.

According to an implementation of the disclosed subject matter, one or more binaries may be associated with a version of an application. A binary may correspond to device capabilities, screen size, selected settings, provider requirements, or the like. A version of an application may contain characteristics corresponding to one or more of device capabilities, screen size, selected settings, provider requirements, or the like. Accordingly, a unique binary may be associated with the specific set of characters associated with that version of the application. A set of users may also be associated with the same binary. As an example, a version of an application may correspond to graphics corresponding to a 1704×960 resolution. The binary associated with this resolution may be 110101. Accordingly, this version of the application with the binary 110101 may be published to mobile devices with a resolution of 1704×960.

According to an implementation of the disclosed subject matter, a price for a version of an application may be determined and associated with the published version of the application. A first and a second version of a published application may be different such as, for example, based on the locale a version is published in, a set of users a version is designated for, or the like. The price may be determined via the application programming interface prior to publishing the application or may be determined by the application market in which the application is published in. As an example, as shown in FIG. 3, a single version of an application 300 may be provided to an application programming interface 340. The application programming interface may generate and publish three versions of the application, versions 310, 320, and 330. The price for version 310 may be $0.49 based on version 310 corresponding to a Chinese market. The price for version 320 may be $0.99 based on version 320 corresponding to a United States market. The price for version 330 may be $1.30 based on version 310 corresponding to a European market. The price for each of multiple versions of an application may be determined automatically such that a developer associated party need not set the price. As an example, a developer associated party may provide only the intended versions of applications that are to be published and, based on the each of the versions, a price may be determined for each version.

According to an implementation of the disclosed subject matter, a version of an application may be updated based on a continuous release period. The continuous release period may be a time based period (e.g., every day, every week, etc.), a release based period (e.g., every time an application is updated), a request period (e.g., every time an updated version of the application is requested, or the like), or the like. An application programming interface may receive a version of an application at a continuous release period and automatically provide or update a current published version of the application in an application market. A developer associated party need not submit the version of the application in this case. The updated version of the application may automatically be provided to the application programming interface and may automatically published (as one or more versions, as disclosed herein), to an application market.

According to an implementation of the disclosed subject matter, a set of in-application items may be determined based on a set of users. An in-application item may be an item that is an add-on to an application. In-application items may be items for sale, items for display, interactive items, language, or the like. As an example, a set of users may be located in the United States. Accordingly, an in-application item for this set of users may be a subscription to the New York Times via a version of the application published for this set of users.

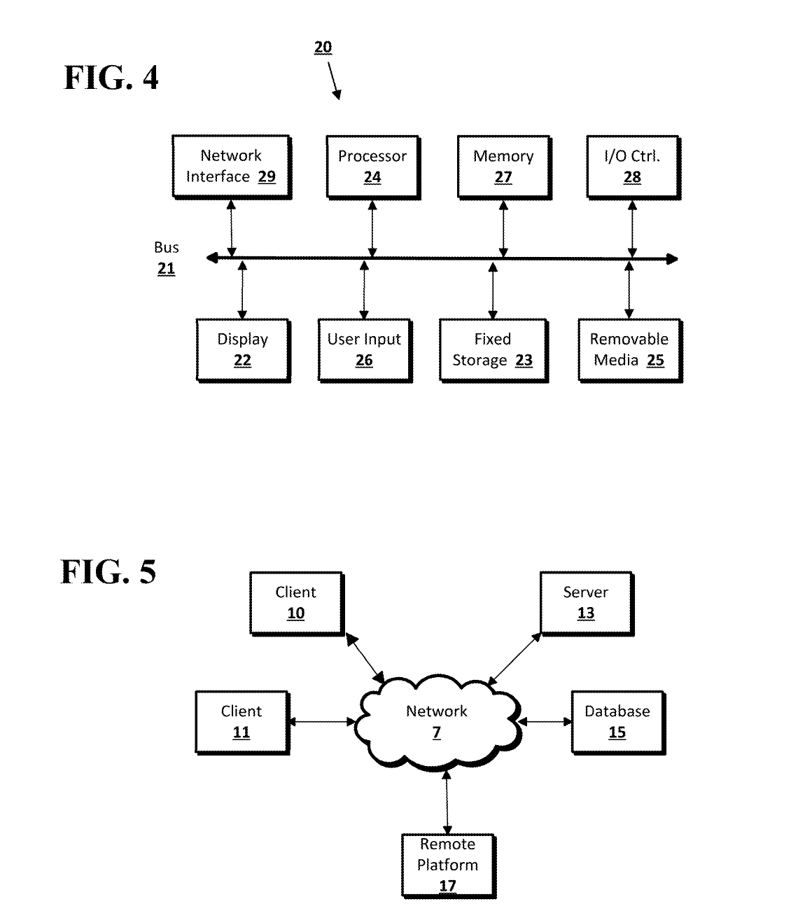

Implementations of the presently disclosed subject matter may be implemented in and used with a variety of component and network architectures. As an example, a mobile phone may be in connection with a cloud server and the cloud server may provide information to an event listener. FIG. 4 is an example computer 20 suitable for implementing implementations of the presently disclosed subject matter. The computer (e.g., mobile phone, tablet, laptop, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 5.

Many other devices or components (not shown) may be connected in a similar manner (e.g., document scanners, digital cameras and so on). Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

FIG. 5 shows an example network arrangement according to an implementation of the disclosed subject matter. One or more clients 10, 11, such as smart power devices, microcomputers, local computers, smart phones, tablet computing devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
providing an application programming interface to a developer associated party, the application programming interface configured to allow automated uploads of multiple versions of an application without requiring individual uploads of each version;
receiving a first version and a second version of the application, via the application programming interface;
publishing the first version of the application in a first language, in an application market, to a first set of users; and
publishing the second version of the application in a second language, in the application market, to a second set of users.

2. The method of claim 1, wherein the application programming interface is configured to receive the first version of the application and the second version of the application based on a single activation.

3. The method of claim 2, wherein the single activation is one selected from the group consisting of: a button press, a code input, and an upload command.

4. The method of claim 1, wherein the developer associated party uses a software to interact with the application programming interface.

5. The method of claim 1, wherein the developer associated party is a translator.

6. The method of claim 1, wherein the first version and the second version of the application is not uploaded via an application market interface.

7. The method of claim 1, further comprising:
determining a first price for the first version of the application;
associating the first price for the first version of the application in the application market;
determining a second price for the second version of the application; and
associating the second price for the second version of the application in the application market.

8. The method of claim 1, further comprising determining the first set of users based on the data associated with the first version of the application.

9. The method of claim 8, wherein the first set of users are associated with a first binary and wherein the first version of the application is also associated with the first binary.

10. The method of claim 1, further comprising determining the second set of users based on the data associated with the second version of the application.

11. The method of claim 10, wherein the second set of users are associated with a second binary and wherein the second version of the application is also associated with the second binary.

12. The method of claim 1, further comprising:
determining a first set of in-application items based on the first set of users; and
providing the first set of in-application items to the first set of users.

13. The method of claim 1, wherein the first version of the application is updated and provided to an application programming interface at a continuous release period.

14. A system comprising:
a first processor configured to:
provide an application programming interface to a developer associated party, the application programming interface configured to allow automated uploads of multiple versions of an application without requiring individual uploads of each version;
a second processor configured to:
receive a first version and a second version of the application, via the application programming interface;
publish the first version of the application in a first language, in an application market, to a first set of users; and
publish the second version of the application in a second language, in the application market, to a second set of users.

15. The system of claim 14, wherein the first processor and the second processor are the same processor.

16. The system of claim 14, wherein the application programming interface is configured to receive the first version of the application and the second version of the application based on a single activation.

17. The system of claim 14, further configured to:
determine a first price for the first version of the application;
associate the first price for the first version of the application in the application market;
determine a second price for the second version of the application; and
associate the second price for the second version of the application in the application market.

18. The system of claim 14, further comprising determining the first set of users based on the data associated with the first version of the application.

19. The system of claim 18, wherein the first set of users are associated with a first binary and wherein the first version of the application is also associated with the first binary.

20. The system of claim 14, further comprising determining the second set of users based on the data associated with the second version of the application.

21. The system of claim 20, wherein the second set of users are associated with a second binary and wherein the second version of the application is also associated with the second binary.
